(19) United States
(12) Patent Application Publication
(10) Pub. No.: US 2015/0100391 A1
(43) Pub. Date: Apr. 9, 2015

(54) Systems And Methods For Discovering An Optimal Operational Strategy For A Desired Service Delivery Outcome

(71) Applicant: INTERNATIONAL BUSINESS MACHINES CORPORATION, Armonk, NY (US)

(72) Inventors: Gargi B. Dasgupta, Gurgaon (IN); Yedendra B. Shrinivasan, Chennai (IN); Jayan Nallacherry, Bangalore (IN); Tapan K. Nayak, New Delhi (IN); Nirmit V. Desai, Bangalore (IN)

(73) Assignee: INTERNATIONAL BUSINESS MACHINES CORPORATION, Armonk, NY (US)

(21) Appl. No.: 14/048,571

(22) Filed: Oct. 8, 2013

(51) Int. Cl. G06Q 10/06

(52) U.S. Cl. CPC G06Q 10/06393
USPC 705/7.39

(57) ABSTRACT

Methods and systems for creating an action plan for a service delivery system comprising a plurality of operational key performance indicators (KPIs). The system receives predetermined information about at least one relationship between two or more of the KPIs, and weights that information based on its source. The system also receives information about operational constraints and desired outcomes. A KPI relationship map is created using both the weighted information and information about KPI relationships within the service delivery system. Future predictions are made based on the KPI relationship map, and the predictions and map are utilized to create an action plan to achieve the desired outcomes in light of the operational constraints.

### FIELD OF THE DISCLOSURE

The present disclosure relates to optimization of service delivery systems, and more particularly to methods and systems for characterizing the interrelation of one or more operational performance indicators and service delivery outcomes.

### BACKGROUND

Although services account for a major source of revenues and employment in many modern economies, service operations management remains extremely complex and unpredictable. Human-provided service delivery systems (“SDs”) tend to be significantly labor-intensive and often miss performance targets as the system involves many complex and interdependent processes.

Service delivery operations can be measured using, among other things, operational key performance indicators (“KPIs”). These KPIs can include, for example, mean time to respond, worker utilization, and workload complexity, among many others. Additionally, to characterize service delivery operation measurements, the interrelationship of KPIs can be modeled as a key performance indicator network. However, in most human-provided services these KPIs are measured at an objective level (as opposed to an instance level in the business process management and service-oriented architecture systems), and the collection of KPIs is a highly manual and typically offline process (as opposed to automated, runtime collect methods in business process management and service-oriented architecture systems).

Often, service delivery outcomes such as “quality of service” are measured against the service level objectives agreed upon by the service provider and the customer, including but not limited to availability, throughput, and response time, among others.

Operational improvements directly impact the operational KPIs as well as the service delivery outcomes, although there may be delays in impacts. For example, a higher utilization of workers may improve service delivery outcomes only after two weeks instead of immediately. Accordingly, there is a continued demand for methods and systems for assisting service providers and/or service delivery managers with gathering information about or within a service delivery operation in order to characterize various aspects of the operation, including but not limited to KPIs and service delivery outcomes. Characterizing these aspects of the service delivery operation will, among other things, allow for enhanced transformation of the operation to a desired state in an optimal timeframe.

### BRIEF SUMMARY

A method for creating an action plan for a service delivery system comprising a plurality of operational key performance indicators (KPIs), the method comprising the steps of: (i) receiving predetermined information about at least one relationship between two or more of the KPIs; (ii) weighting the predetermined information about at least one relationship between two or more of the KPIs, wherein the weight is dependent upon the source of the predetermined information; (iii) receiving information about at least one operational constraint on the service delivery system; (iv) receiving information about at least one desired outcome of the service delivery system; (v) determining a plurality of KPI relationships within the service delivery system, wherein each KPI relationship is between two or more of the KPIs and comprises a degree of influence attribute and a rate of influence attribute; (vi) determining, utilizing the weighted predetermined information and the plurality of determined KPI relationships, a KPI relationship map; (vii) predicting for a future time period, utilizing the KPI relationship map, at least one service delivery outcome; and (viii) creating an action plan to achieve the at least one desired outcome of the service delivery system, wherein the action plan is limited by the at least one operational constraint on the service delivery system, and further wherein the action plan comprises information about an operational target for at least one KPI.

According to one aspect, the degree of influence attribute (of one KPI on another) is determined by measuring a correlation co-efficient between the two KPIs.

According to another aspect, the method further comprises the step of determining a cost of achieving the at least one desired outcome of the service delivery system.

A computerized system for creating an action plan for a service delivery system comprising a plurality of operational key performance indicators (KPIs), the system comprising: (i) an input module adapted to receive: (a) predetermined information about at least one relationship between two or more of the KPIs; (b) information about at least one operational constraint on the service delivery system; and (c) information about at least one desired outcome of the service delivery system; and (ii) a processor adapted to: weight the predetermined information about at least one relationship between two or more of the KPIs, wherein the weight is dependent upon the source of the predetermined information; determine a plurality of KPI relationships within the service delivery system, wherein each KPI relationship is between two or more of the KPIs and comprises a degree of influence attribute and a rate of influence attribute; determine, utilizing the weighted predetermined information and the plurality of determined KPI relationships, a KPI relationship map; predict for a future time period, utilizing the KPI relationship map, at least one service delivery outcome; and create an action plan to achieve the at least one desired outcome of the service delivery system, wherein the action plan is limited by the at least one operational constraint on the service delivery system, and further wherein the action plan comprises information about an operational target for at least one KPI.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a flowchart depicting a method for characterizing the interrelation of one or more operational performance indicators and service delivery outcomes according to an embodiment;

FIG. 2 is a schematic representation of a system for characterizing the interrelation of one or more operational performance indicators and service delivery outcomes according to an embodiment;

FIG. 3 is a schematic representation of information about the degree and rate of influence between staffing and one or more process KPIs according to an embodiment;

FIG. 4 is a graph predicting the outcome of one or more aspects of a service delivery system according to an embodiment; and

FIG. 5 is a schematic representation of the relationship between KPI a, KPI b, and KPI c according to an embodiment.

### DETAILED DESCRIPTION

According to an embodiment of the system, the operational process quality is characterized by measuring the level of compliance the service delivery system has with the service delivery framework (“SDF”) and its performance. An analytical model is developed to predict service delivery outcomes as functions of KPI values, and a systems dynamics model is constructed to capture the relationships between operational processes and service delivery outcomes. Integration of the system dynamics model with the prediction model provides quantifiable and qualitative information about how a service delivery system can reach optimal performance levels in order to satisfy the service level objectives.

According to an embodiment, the system or method can provide information or recommendations about how the service delivery system can reach optimal performance levels in order to satisfy the service level objectives. For example, the system or method can provide one or more of the following recommendations or categories of information:
The effect(s) of individual operational processes on one another;
Key operations of service delivery system which require improvements, its future state and its effect(s) on other processes, and the service delivery outcome; and/or
A visualization depicting, among many other things, the path of improvements which also provide a degree of influence, the predicted state of operational metrics, the predicted state of service delivery outcomes, or optimal paths for attaining one or more desired service delivery outcomes, among others.
   This list is not exhaustive, and any aspect of this service delivery system or framework can form all or part of a recommendation made by the system or method.

According to yet another embodiment, the system or method provides a schedule or time-dependent recommendations for an action plan to transform or alter the current service delivery system or framework in such a manner as to achieve the service level objectives in a more optimal way or timeframe. Further, the system or method can provide an estimate of the cost of transforming or altering the current service delivery system or framework in such a manner as to make the system service level objective-compliant or otherwise more efficient.

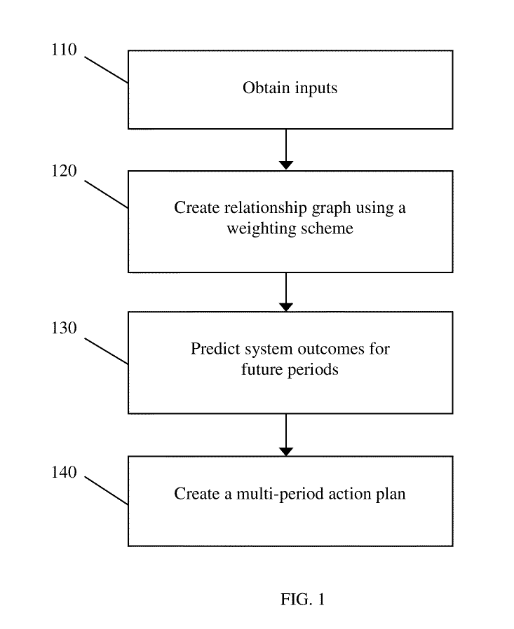

Referring now to the drawings, wherein like reference numerals refer to like parts throughout, there is seen in FIG. 1 a flowchart of a method 100 for characterizing and visualizing the interrelationships of operational KPIs and service delivery outcomes according to an embodiment.

At step 110 of method 100, inputs are obtained or provided. According to an embodiment, inputs include but are not limited to: (i) services KPI-KPI and KPI-outcome influence relationships having attributes such as degree of influence and rate of influence; (ii) operational constraints; (iii) desired service delivery outcomes; and (iv) other sources of information including time-series data, service delivery domain expert inputs, shared knowledge gathered from history or crowd, and others. These inputs can be entered into the system manually by a user, can be determined independently by the system, or can be a combination of these and other sources.

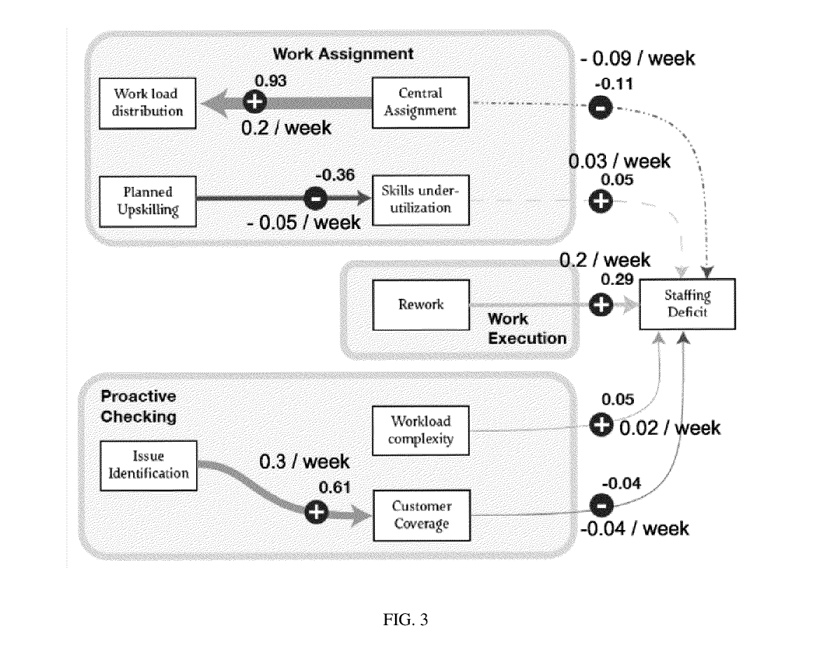

As just one example, input can include information about the degree and rate of influence between staffing and one or more process KPIs, as depicted in FIG. 3. In this example, the relationship between a KPI such as worker utilization or workload complexity and other KPI or a service delivery outcome can be determined, and this relationship can be characterized by an attribute such as the degree of influence (for example how much of an impact the KPI has on another KPI or on a service delivery outcome), or the rate of influence (how quickly or slowly a KPI impacts another KPI or a service delivery outcome), among other attributes.

### EXAMPLE 1

According to one embodiment, the rate of influence is calculated or estimated by the following calculation:

Rate of Influence=Degree of Influence/Time of Influence

In a service delivery system where both operational and outcome KPI measurement is based on as-is states, the Degree of Influence can be measured by the correlation co-efficient between the operational (cause) and the outcome (effect) metric.

In this example, consider a pair of cause and effect metrics (X, Y) with data collected for T timestamps, such as X=[X₁, X₂, . . . X_{T}], and Y=[Y₁, Y₂, . . . Y_{T}]. If h (in weeks) is the maximum timelag possible between a cause and an effect, then a, is defined as the correlation co-efficient between metrics X and Y at timelag i (in weeks), where a₀ is the correlation when the cause takes effect instantaneously with no delay, and a₁ is the correlation when the cause takes effect after 1 week, and so forth where a_{N} is the correlation when the cause takes effect after N weeks.

The set S=[a₀, a₁, . . . a_{b}] is computed at timelags [t₀, t₁, . . . tₕ]. If aₘₐₓ denotes the max value of set S, for example aₘₐₓ>=aᵢ, for all i<=h, then tₘₐₓ defines the optimal lag (in weeks) where the effect of cause is maximal on the effect. As a result, the Rate of Influence is calculated by the formula:

r_{xy}=aₘₐₓ/(tₘₐₓ+1)

As another example, input can include information about operational constraints and/or desired service delivery outcomes. For example, operational constraints can include one or more limits on the highest allowable rate of change within the system or framework. Operational constraints may also include, for example, a limitation or restriction on which processes cannot be improved together. For example, the system may be limited or constrained such that planned upskilling and rework cannot be altered, improved, or scheduled for improvement simultaneously, one after the other, or according to some other arrangement in space or time. Desired service delivery outcomes can include, for example, minimizing staffing deficits, maximizing service-level agreement or arrangement performance, or achieving a certain level of service-level agreement or arrangement performance, among many others.

At step 120 of method 100, the method or system creates a validated KPI-KPI and KPI-Outcome relationship graph from the different sources of information using a weighing scheme among the sources. The weights can be learned over time based on the accuracy of the sources, or can be determined or predetermined using known mechanisms.

### EXAMPLE 2

According to one embodiment, the method or system maintains a weight of confidence for each of the sources of information and the final KPI relationship is a weighted combination. For example, S1, S2, and S3 can be three sources of information for every relationship edge eᵢⱼ between nodes vᵢ and vⱼ and αᵢⱼ (t), βᵢⱼ (t), and γᵢⱼ are the corresponding weights, where s1 and s2 are sources from experts or knowledge databases and s3 is the information extracted from data. The relationship between the node vᵢ and vⱼ is valid if the sum of the weights αᵢⱼ (t)+βᵢⱼ (t)+and γᵢⱼ rᵢⱼ(t) is greater than a threshold value vᵢⱼ rᵢⱼ the measured value from data at t. According to this embodiment, the weights αᵢⱼ (t) and βᵢⱼ (t) can be updated dynamically based on the measured value from data, such as the following:

αᵢⱼ(t+1)=(1−p)αᵢⱼ(t)+prᵢⱼ(t)

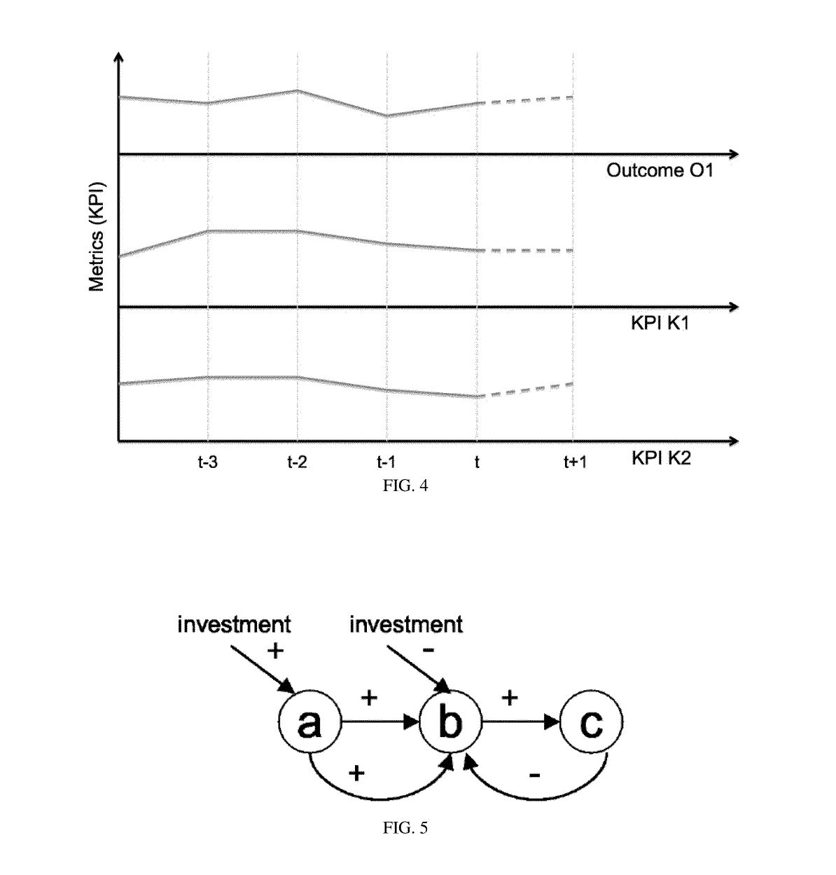

At step 130 of method 100, the method or system predicts the outcome for the future periods (for example, t+1, t+2, t+3, etc.) given one or more of the relationships described above, as depicted in FIG. 4.

At step 140 of method 100, the method or system produces a multi-period action plan that specifies the target performance levels for each of the independent KPIs for each period to achieve the desired service delivery outcomes.

### EXAMPLE 3

According to one embodiment, the method or system creates a three-week action plan to specify the target performance levels for each of the independent KPIs for each period in order to achieve the desired service delivery outcomes. In this example, the system is considering three KPIs called a, b, and c which are related as shown in FIG. 5. The desired outcome in this example is to move “c” to a value of 0.8.

According to this action plan, at week 1, KPI “a” should be increased due to an inflow of investment of c1, where the net outcome value of c converges to 0.7. At week 2, KPI “b” should be increased due to a further investment of c2, where the net outcome value is 0.68. At week 3, KPI “a” should be further increased due to an investment of c3, where the net outcome value is 0.81. This action plan therefore attains a net value of 0.81 at end of third week, with a total cost of c1+c2+c3. The cost reflects the investments that trigger change in KPIs “a” and “b.” Here, Φₐ(I1, I2) can be the cost function that denotes the cost in terms of $ of moving KPI “a” from value I1 to value I2.

Given a KPI network, therefore, the following steps can be taken to find the optimal action plan Opt_{PATH} which achieves a desired outcome M and minimizes cost. For example, consider a set of N KPIs, each of which can be incremented by a step-size of i in 1 week. The method or system generates i*N*N! sequences of actions. Here, Cₘᵢₙ=infinity. Therefore, for each sequence p, run a Systems Dynamics Simulation Model to find the outcome value m. If m<M then discard the solution, but if m>=M, find the cost of investment C give by Φ. If C<Cₘᵢₙ, OPt_{PATH}=p. The system or method then returns Opt_{PATH} and Cₘᵢₙ.

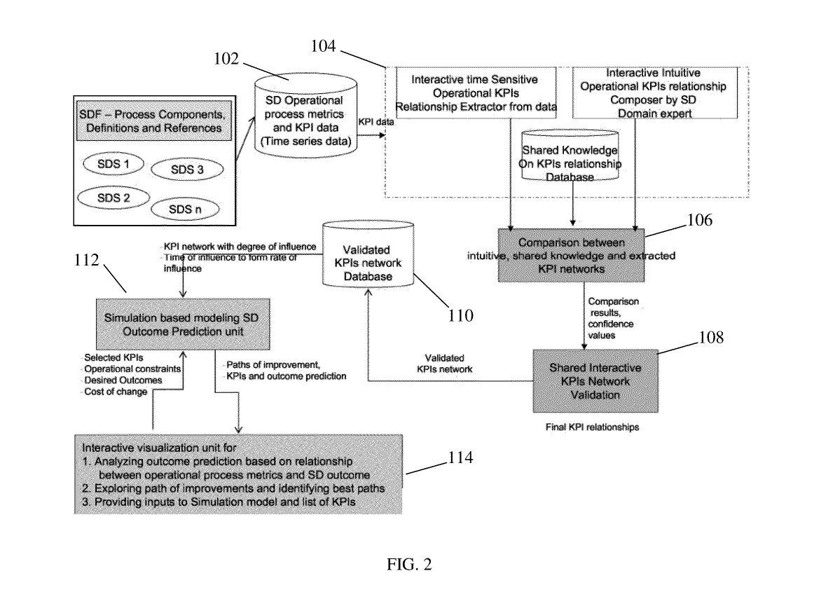

There is shown in FIG. 2 a system for characterizing and visualizing the interrelationships of operational KPIs and service delivery outcomes according to an embodiment. As an initial step, inputs are obtained or provided, which can include but are not limited to: (i) services KPI-KPI and KPI-outcome influence relationships having attributes such as degree of influence and rate of influence; (ii) operational constraints; (iii) desired service delivery outcomes; and (iv) other sources of information including time-series data, service delivery domain expert inputs, shared knowledge gathered from history or crowd, and others. These inputs can be entered into the system manually by a user, can be determined independently by the system, or can be a combination of these and other sources. For example, the inputs can be determined, isolated, created, mined, extracted, processed, or otherwise input or fed into system 100 by an input module 104, which can communicate with storage mechanism 102 which contains stored service delivery operational process metrics and KPI data (such as time series data), among other data.

Input module 104 can, for example, extract time-sensitive operational KPI relationships from data, or compose operational KPI relationships, or store or share knowledge about KPIs from a KPI relationship database.

The system can also comprise a comparison module 106, which can, for example, make comparisons between shared knowledge and one or more extracted KPI networks or other KPI data. The results, including comparison results and confidence values, can be utilized by a validator module 108 to validate or otherwise analyze the KPI network in order to validate or create a list, ranking, or other compilation of KPI relationships which can then be stored in a validated KPIs network database 110.

The stored KPI network information, which may include data about one or more degrees of influence and/or the time of influence can be fed into or retrieved by a predictor module 112. The predictor module 112 predicts service delivery outcomes in a simulation-based manner utilizing the stored KPI network information. The information utilized by (and thus, generated by) the predictor module 112 can include, among many other things, selected KPIs, operational constraints, desired outcomes, cost of change, paths of improvement, and KPIs and outcome predictions.

A visualization module 114 then creates a visualization of the generated information, including but not limited to analyzing the outcome prediction based on a relationship between the operational process metrics and the service delivery outcome, exploring paths of improvements and identifying the best path(s), and providing inputs to the simulation model and lists of KPIs.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

What is claimed is:

1. A method for creating an action plan for a service delivery system comprising a plurality of operational key performance indicators (KPIs), the method comprising the steps of:
receiving predetermined information about at least one relationship between two or more of said KPIs;
weighting said predetermined information about said at least one relationship between two or more of said KPIs, wherein said weight is dependent upon the source of said predetermined information;
receiving information about at least one desired outcome of said service delivery system;
determining a plurality of KPI relationships within said service delivery system, wherein each KPI relationship is between two or more of said KPIs and comprises a degree of influence attribute;
determining, utilizing the weighted predetermined information and the plurality of determined KPI relationships, a KPI relationship map;
predicting for a future time period, utilizing said KPI relationship map, at least one service delivery outcome; and
creating an action plan to achieve said at least one desired outcome of said service delivery system, and further wherein said action plan comprises information about an operational target for at least one KPI.

2. The method of claim 1, wherein the degree of influence attribute is determined by measuring a correlation co-efficient between a first of said plurality of KPIs, and a second of said plurality of KPIs.

3. The method of claim 1, further comprising the step of determining a cost of achieving said at least one desired outcome of said service delivery system.

4. The method of claim 1, wherein each KPI relationship further comprises a time of influence attribute.

5. The method of claim 4, wherein each KPI relationship further comprises a rate of influence attribute calculated utilizing said the degree of influence attribute and the time of influence attribute associated with that KPI relationship.

6. The method of claim 1, further comprising the step of receiving information about at least one operational constraint on said service delivery system, and wherein said action plan is limited by said at least one operational constraint on said service delivery system.

7. The method of claim 6, wherein said operational constraint is a limit on a maximum rate of change of an operational metric within the service delivery system.

8. The method of claim 1, wherein said weight can be dynamically updated.

9. The method of claim 1, wherein said action plan can be dynamically updated.

10. The method of claim 1, wherein each KPI relationship further comprises a rate of influence attribute calculated utilizing the following formula:
r_{xy}=aₘₐₓ/(tₘₐₓ+1)
wherein r=the rate of influence;
wherein x=an operational metric;
wherein y=an outcome metric;
wherein aₘₐₓ=a maximum value for a set S=[a₀, a₁, a₁₊₁, a₁₊₂, . . . ], wherein a is a correlation co-efficient between x and y; and
wherein tₘₐₓ=an optimal amount of time between the operational metric occurring and the outcome metric being maximally affected.

11. A computerized system for creating an action plan for a service delivery system comprising a plurality of operational key performance indicators (KPIs), the system comprising:
an input module adapted to receive: (i) predetermined information about at least one relationship between two or more of said KPIs; and (ii) information about at least one desired outcome of said service delivery system; and
a processor, said processor adapted to:
weight said predetermined information about at least one relationship between two or more of said KPIs, wherein said weight is dependent upon the source of said predetermined information;
determine a plurality of KPI relationships within said service delivery system, wherein each KPI relationship is between two or more of said KPIs and comprises a degree of influence attribute;
determine, utilizing the weighted predetermined information and the plurality of determined KPI relationships, a KPI relationship map;
predict for a future time period, utilizing said KPI relationship map, at least one service delivery outcome; and
create an action plan to achieve said at least one desired outcome of said service delivery system, wherein said action plan comprises information about an operational target for at least one KPI.

12. The system of claim 11, wherein the degree of influence attribute is determined by measuring a correlation co-efficient between a first of said plurality of KPIs, and a second of said plurality of KPIs.

13. The system of claim 11, wherein said processor is further adapted to determine a cost of achieving said at least one desired outcome of said service delivery system.

14. The system of claim 11, wherein each KPI relationship further comprises a time of influence attribute.

15. The system of claim 14, wherein said input module is further adapted to receive information about at least one operational constraint on said service delivery system, and wherein said action plan is limited by said at least one operational constraint on said service delivery system.

16. The system of claim 15, wherein said operational constraint is a limit on a maximum rate of change of an operational metric within the service delivery system.

17. The system of claim 14, wherein each KPI relationship further comprises a rate of influence attribute.

18. The system of claim 11, wherein said processor is further configured to dynamically update said weight.

19. The system of claim 11, wherein said processor is further configured to dynamically update said action plan.

20. The system of claim 11, wherein said processor is configured to calculate a rate of influence attribute for one or more of said KPI relationships utilizing the following formula:
r_{xy}=aₘₐₓ/(tₘₐₓ+1)
wherein r=the rate of influence;
wherein x=an operational metric;
wherein y=an outcome metric;
wherein aₘₐₓ=a maximum value for a set S=[a₀, a₁, a₁₊₁, a₁₊₂, . . . ], wherein a is a correlation co-efficient between x and y; and
wherein tₘₐₓ=an optimal amount of time between the operational metric occurring and the outcome metric being maximally affected.
